(19) United States
(12) Patent Application Publication
(10) Pub. No.: US 2026/0300627 A1
(43) Pub. Date: Oct. 1, 2026

(54) SYSTEM AND METHOD FOR SEGMENTING INTERACTIONS

(71) Applicant: GENESYS CLOUD SERVICES, INC., MENLO PARK, CA (US)

(72) Inventors: AVRAHAM FAIZAKOF, TEL-AVIV (IL); EYAL ORBACH, MENLO PARK, CA (US); ROTEM MAOZ, TEL-AVIV (IL); NELLY DAVID, TEL-AVIV (IL)

(73) Assignee: GENESYS CLOUD SERVICES, INC., MENLO PARK, CA (US)

(21) Appl. No.: 19/629,689

(22) Filed: Mar. 26, 2026

Related U.S. Application Data
(60) Provisional application No. 63/779,950, filed on Mar. 28, 2025.

(51) Int. Cl. G06F 40/289; G06F 16/334; G06F 16/38

(52) U.S. Cl. CPC G06F 40/289; G06F 16/3344; G06F 16/38

(57) ABSTRACT

The present invention provides a method and system for segmenting an interaction. A computing device obtains an interaction data element that may include a plurality of lines, each representing a contribution of a specific participant to the interaction. Using at least one first language model, a list of line indices representing segmentation of the interaction data element into segments of distinct topics is generated. The list of line indices is evaluated to identify inconsistency of the segmentation. When inconsistency is identified, a refined segmentation is generated by at least one second language model, wherein the at least one second language model is more computationally intensive than the at least one first language model. The method and system enable efficient and accurate segmentation of interactions for improved analysis and searchability.

### CROSS REFERENCE TO RELATED APPLICATION

This application claims priority to U.S. Provisional Patent Application No. 63/779,950, titled “SYSTEM AND METHOD FOR SEGMENTING INTERACTIONS”, filed Mar. 28, 2025, which is hereby incorporated by reference in its entirety.

### FIELD OF INVENTION

The present invention relates to the field of automated interaction analysis. More particularly, the present invention relates to a system and method for automatically segmenting interactions using language models, to facilitate efficient review and analysis.

### BACKGROUND

Contact centers play an important role in modern business operations, serving as a primary interface between companies and their customers. These centers handle a high volume of interactions daily, including phone calls, emails, and chat sessions. As the complexity and volume of customer interactions continue to grow, there is an increasing need for efficient methods to analyze and derive insights from these interactions.

Traditionally, supervisors and quality assurance teams have relied on manual review processes to evaluate customer interactions. This approach involves listening to recorded calls or reading through chat transcripts line by line. While thorough, this method can be time-consuming and resource-intensive, especially when dealing with longer interactions or attempting to analyze trends across multiple conversations.

The advent of Natural Language Processing (NLP) technologies has opened up new possibilities for automating the analysis of customer interactions. These technologies can process and interpret human language, potentially allowing for more efficient review and categorization of large volumes of text data. However, applying NLP techniques to contact center interactions presents unique challenges due to the diverse nature of customer inquiries, the presence of industry-specific terminology, and the need to accurately capture the context and flow of conversations.

As contact centers continue to evolve and handle increasingly complex customer inquiries, there is an ongoing need for innovative solutions that can help streamline the analysis process of customer interactions, improve the quality of customer service, and provide valuable insights to businesses. Addressing these challenges could lead to more efficient operations, improved customer satisfaction, and better-informed decision-making within contact center environments.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In an embodiment, a method is presented for segmenting an interaction into a plurality of segments of distinct topics, by at least one processor, the method comprising: obtaining an interaction data element that may include a plurality of lines, wherein each line represents a contribution of a specific participant to the interaction; generating, using at least one first language model, a list of line indices representing segmentation of the interaction data element into the plurality of segments of distinct topics; evaluating the list of line indices, to identify inconsistency of the segmentation; and when inconsistency is identified, generating a refined segmentation of the plurality of segments of distinct topics by at least one second language model, wherein the at least one second language model is more computationally intensive than the at least one first language model.

According to other aspects of the present invention, the method may include one or more of the following features. The inconsistency may be selected from a list comprising: (i) a gap in the list of line indices, (ii) an overlap in the list of line indices, and (iii) disorder within the list of line indices.

The method may further comprise for each segment of the plurality of segments of distinct topics: applying the at least one first language model on lines of the segment, to generate an initial title indicative of the segment's topic; applying the at least one first language model on lines of the segment to generate a description of content of the segment; and associating the initial title and description to line indices of that segment thereby producing a descriptive segment metadata structure.

The method may also include evaluating semantic similarity between the generated initial title and titles of a list of predefined titles; and when the semantic similarity exceeds a predetermined threshold, replacing the assigned initial title in the segment metadata structure with a respective title from the list of predefined titles.

The method may further include presenting the segment metadata structures on a user interface; and enabling search functionality via the user interface, wherein the search functionality allows searching of the interaction data element based on the titles and descriptions of the segment metadata structures.

The method may also include storing the descriptive segment metadata structures and associated interaction data elements in a database; receiving a search query through the user interface; searching the database to identify matching segment metadata structures based on the search query; retrieving lines or snippets from the interaction data elements associated with the matching segment metadata structures; and presenting the retrieved lines or snippets on the user interface, along with contextual information including at least one of: the associated titles, descriptions, line indices, participant information, timestamps.

The method may further include obtaining the interaction data element by: receiving audio data of the interaction; transcribing the audio data, to obtain textual representation of the interaction; identifying participants in the interaction; enumerating lines of the transcribed text to distinguish between contributions of each identified participant; and associating each enumerated line with its corresponding participant.

In an embodiment, the at least one first language model comprises two or more language-specific models, and the method may further include: detecting multiple languages within the interaction data element; applying a language-specific model for segmentation and title generation in each detected language; and consolidating results of descriptive segment metadata structures from each of the language-specific models into a unified set of segment metadata structures.

In an embodiment, the method may also include: receiving, via a user interface, feedback on the generated segment metadata structures; storing the feedback in association with the corresponding interaction data elements and generated description; and periodically retraining the at least one first language model and the at least one second language model using the stored user feedback to improve segmentation accuracy.

According to another aspect of the present invention, a system for segmenting interactions is provided. The system may include a non-transitory memory device, wherein modules of instruction code are stored, and at least one processor associated with the memory device, and configured to execute the modules of instruction code, whereupon execution of said modules of instruction code, the at least one processor is configured to: obtain an interaction data element comprising a plurality of lines, wherein each line represents a contribution of a specific participant to the interaction; generate, using at least one first language model, a list of line indices representing segmentation of the interaction data element into segments of distinct topics; evaluate the list of line indices, to identify inconsistency of the segmentation; and when inconsistency is identified, generate a refined segmentation by at least one second language model, wherein the at least one second language model is more computationally intensive than the at least one first language model.

According to other aspects of the present invention, the system may include one or more of the following features. The inconsistency may be selected from a list comprising: (i) a gap in the list of line indices, (ii) an overlap in the list of line indices, and (iii) disorder within the list of line indices.

The at least one processor may be further configured to, for each segment: apply the at least one first language model on lines of the segment, to generate an initial title indicative of the segment's topic; apply the at least one first language model on lines of the segment, to generate a description of content of the segment; and associate the initial title and description to line indices of that segment, thereby producing a descriptive, segment metadata structure.

The at least one processor may be further configured to: evaluate semantic similarity between the generated initial title and titles of a list of predefined titles; and when the semantic similarity exceeds a predetermined threshold, the at least one processor may replace the assigned initial title in the segment metadata structure with a respective title from the list of predefined titles.

The at least one processor may be further configured to present the segment metadata structures on a user interface; and enable search functionality via the user interface, wherein the search functionality allows searching of the interaction data element based on the titles and descriptions of the segment metadata structures.

In an embodiment, the at least one processor may be further configured to: store the descriptive segment metadata structures and associated interaction data elements in a database; receive a search query through the user interface; search the database to identify matching segment metadata structures based on the search query; retrieve lines or snippets from the interaction data elements associated with the matching segment metadata structures; and present the retrieved lines or snippets on the user interface, along with contextual information, selected from a list comprising at least one of: the associated titles, descriptions, line indices, participant information, and timestamps.

The at least one processor may be further configured to obtain the interaction data element by: receiving audio data of the interaction; transcribing the audio data, to obtain textual representation of the interaction; identifying participants in the interaction; enumerating lines of the transcribed text to distinguish between contributions of each identified participant; and associating each enumerated line with its corresponding participant.

In an embodiment, the at least one first model may comprise two or more language-specific models, and the at least one processor may be further configured to: detect multiple languages within the interaction data element; apply a language-specific model for segmentation and title generation in each detected language; and consolidate results of segment metadata structures from each of the language-specific models into a unified set of segment metadata structures.

The at least one processor may be further configured to: receive, via the user interface, feedback on the generated segment metadata structures; store the feedback in association with the corresponding interaction data elements and generated description; and periodically retrain the at least one first language model and the at least one second language model using the stored user feedback to improve segmentation accuracy.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a block diagram, illustrating a computing device, which may be included in a system for segmenting an interaction, according to aspects of the present disclosure;

FIG. 2 is a block diagram, illustrating a system for segmenting interactions, according to some embodiments of the invention; and

FIG. 3 is a flowchart, showing a process of segmenting interactions, according to aspects of the present invention.

### DETAILED DESCRIPTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Large Language Models (LLMs) have emerged as a promising tool in the field of NLP. These models, trained on vast amounts of text data, have demonstrated capabilities in various language-related tasks, including text summarization, sentiment analysis, and machine translation. The application of LLMs to contact center interaction analysis offers new ways to streamline the review process and extract valuable insights.

However, despite the potential benefits of automated analysis tools, there remains a need for solutions that can accurately segment interactions into logical parts while maintaining the context and nuance of customer conversations. Embodiments of the invention may be adapted to overcome such shortcomings of currently available solutions, allowing users to quickly navigate specific portions of an interaction, such as the reason for contact or a resolution of that reason, without the need for time-consuming manual review.

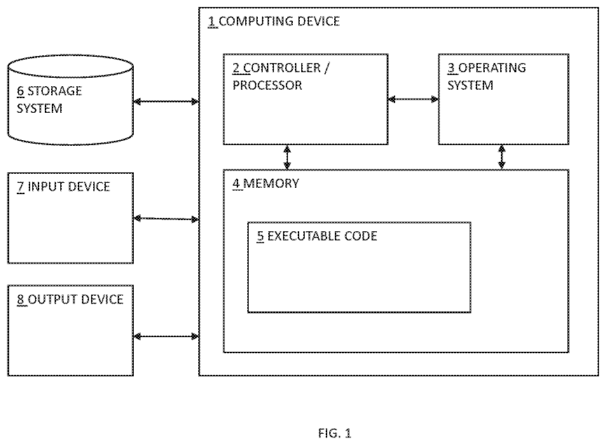

Reference is now made to FIG. 1, which is a block diagram depicting a computing device, which may be included within an embodiment of a system for segmenting interactions, according to some embodiments. Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may be adapted to segment interactions as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data pertaining to interactions (e.g., chats, discussions, and the like) may be stored in storage system 6 and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multipurpose or specific processors or controllers (e.g., similar to element 2), a plurality of input units, a plurality of output units, a plurality of memory units, and a plurality of storage units.

The term neural network (NN) or artificial neural network (ANN) (e.g., a neural network implementing a machine learning (ML) model, or artificial intelligence (AI) function), may be used herein to refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. At least one processor (e.g., processor 2 of FIG. 1) such as one or more CPUs or graphics processing units (GPUs), or a dedicated hardware device may perform the relevant calculations.

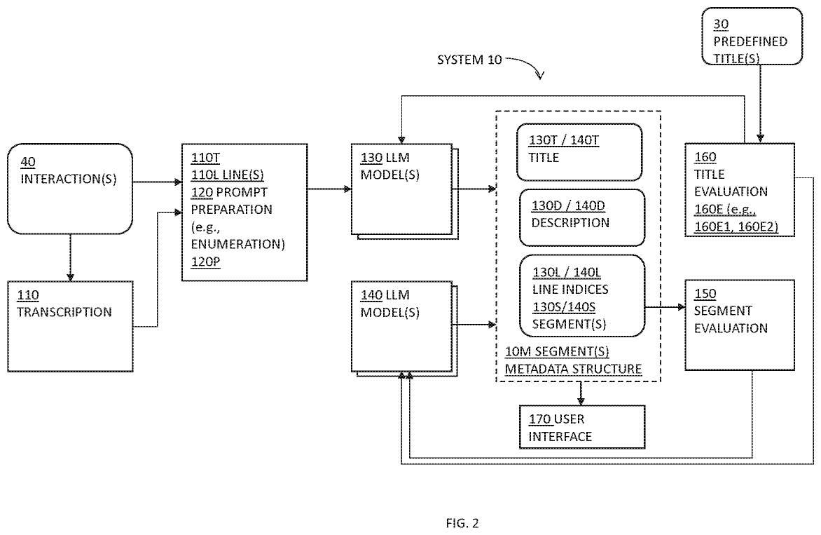

Reference is now made to FIG. 2, which depicts a system 10 for segmenting interactions 40, according to some embodiments of the invention. System 10 may be implemented as a software module, a hardware module, or any combination thereof. For example, system 10 may be or may include a computing device such as element 1 of FIG. 1, and may be adapted to execute one or more modules of executable code (e.g., element 5 of FIG. 1) to segment interactions, as further described herein.

As shown in FIG. 2, arrows may represent flow of one or more data elements to and from system 10 and/or among modules or elements of system 10. Some arrows have been omitted on FIG. 2 for the purpose of clarity. Embodiments of the invention may use a two-tier approach, allowing efficient utilization of computational resources. As described herein, system 10 may employ at least one first, fast, inexpensive language model 130, followed by a second, more expensive and computationally intensive language model 140 if needed. This approach may offer several advantages, such as: efficiency, cost-effectiveness, scalability, adaptive processing, quality assurance, resource optimization, flexibility, and continuous improvement.

With regard to efficiency, the faster and less expensive language model 130 may be sufficient to accurately segment the interaction 40. By using this model first, the system may process a multitude of interactions 40 quickly and efficiently.

Language model 130 may typically consume fewer computational resources than language model 140, which may translate to lower operational costs, especially when processing large volumes of interactions 40.

The two-tiered approach is scalable and allows embodiments of the invention to handle a higher volume of interactions 40 overall, as only a subset of interactions 40 that may require more complex analysis would be processed by the more intensive language model 140.

Adaptive processing allows system 10 to adapt processing power based on the complexity of each interaction 40. Simple interactions 40 may be handled quickly, while more complex ones may receive additional attention.

The second, more intensive language model 140 may serve as a fallback option to ensure high-quality segmentation for challenging or complex interactions 40, providing improved quality assurance.

By reserving the more powerful language model 140 for only those cases where needed, system 10 may optimize the use of computational resources across a multitude of interactions 40.

Flexibility is provided to balance between speed and accuracy based on specific use cases or requirements. The threshold for switching to the more intensive model could be adjusted as needed.

The two-tier process may continuously provide valuable data on which interactions 40 require more intensive processing, potentially informing future improvements to the faster model.

In summary, the two-tier process may strike a balance between efficiency and accuracy, allowing for rapid processing of most interactions 40 while ensuring high-quality results for more challenging cases. This approach may be particularly beneficial in systems that may require handling large volumes of interactions 40 with varying complexity.

As shown in FIG. 2, segmentation system 10 may receive interaction data 40 as input and process this data through various components to generate segmented outputs. In some cases, segmentation system 10 may provide segmentation on-demand, when an interaction is loaded into the system. Additionally, or alternatively, the segmentation system 10 may apply segmentation to a plurality of available interactions 40, that may be stored in a repository or database (e.g., storage 6 of FIG. 1), allowing for aggregation of segmentation results.

Segmentation system 10 may include several components for processing the interaction data 40. In an embodiment, these components may include a transcription module 110, a preparation module 120, language models 130 and 140, a segmentation evaluation module 150, a title analysis module 160, and a user interface 170. Each of these components may play a specific role in the segmentation process, working together to analyze and segment the interaction data 40 effectively.

According to some embodiments, segmentation system 10 may obtain interaction data 40 as textual data (also denoted 110T), representing an interaction such as a textual chat, or correspondence between two or more participants (e.g., an agent and a customer). Additionally, or alternatively, segmentation system 10 may obtain interaction data 40 as an audio data element, representing an interaction such as a phone discussion. In such embodiments, transcription module 110 may transcribe the audio data 40 to obtain a textual representation 110T of interaction 40.

In an embodiment, preparation module 120 may process interaction 40 and/or textual representation 110T to identify participants in the interaction. For example, preparation module 120 may employ a speaker identification algorithm on an audio interaction data element 40, to identify portions of interaction 40 as pertaining to, or uttered by specific participants of interaction 40.

Preparation module 120 may enumerate lines 110L of the transcribed text 110T to distinguish between contributions of each identified participant. Preparation module 120 may associate each enumerated line 110L with its corresponding participant. Preparation module 120 may thereby produce an enumerated, textual version 120P of interaction data element 40. Enumerated, textual interaction data element 120P may include a plurality of text lines 110L, where each line 110L represents a contribution of a specific participant to the interaction. By processing the interaction data 40 in this manner, segmentation system 10 may prepare the interaction data 40 for further analysis and segmentation by subsequent components.

As elaborated herein segmentation system 10 may utilize a first language model 130 to generate an initial segmentation of the interaction data 40. IN an embodiment language model 130 may be implemented using a Claude 3 Haiku ML model, which is part of the currently available Claude family of Large Language Models (LLMs).

According to some embodiments, language model 130 may be trained to generate a list of line indices 130L representing segmentation of the interaction data element 40 into segments of distinct topics. The list of line indices 130L may correspond to the enumerated lines 110L produced by the preparation module 120, allowing for efficient referencing of specific portions of the interaction without requiring the full text to be output. In this context, the list of line indices 130L may also be used herein to refer to a segmentation (e.g., reference to one or more segments) of interaction data element 40.

For example, a list of line indices 130L may be formatted to separate between groups of line indices of enumerated, textual interaction data element 120P, where each group indicates a segment of interaction 40, pertaining to a corresponding topic. For example, list 130L may be, or may include the following entries: {(L₁,L₂,L₃); (L₄,L₅,L₆,L₇); (L₈,L₉,L₁₀)}, where L₁-L₁₀ are line indices. List 130L may thereby define (a) a first segment 130S(S₁) of interaction 40, having a first topic, spanning lines 110L (L₁-L₃); (b) a second segment 130S (S₂) of interaction 40, having a second topic, spanning lines 110L (L₄-L₇); and a third segment 130S (S₃) of interaction 40, having a third topic.

As known in the art, computational (and subsequently-financial) cost of operating an online, Machine Learning (ML)-based LLM may depend upon the number of generated, or predicted tokens. Embodiments of the invention may perform efficient segmentation of interaction data 40 by emitting lists of line indices 130L as representing corresponding segments, rather than emitting actual batches of text tokens (e.g., words) that define each segment. In other words, by using line indices instead of full lines of text, the segmentation system 10 may reduce the number of output tokens and potentially lower processing costs.

It may be appreciated that currently available LLM models may struggle with prediction of numerical values. During development, the inventors have experienced poor results by using line indices to indicate segmentation. However, following enumeration of lines 110L of textual data format 110T, the inventors have experimentally observed an improvement in accuracy of line index 130L prediction, providing accurate definitions of topic-related segmentations.

For example, a textual representation 110T of a discussion between a customer is provided in Example 1, below, where the customer's lines are marked bold, and the agent lines are marked italic:

### Example 1

Hello, my name is Daniel
Hi there
How may I help you?
I am having a problem with my phone
What seems to be the problem
The phone will not turn on . . .

In this condition (textual representation 110T as in Example 1), the inventors have observed that LLM model 140 may perform poorly, in a sense that it could not infer line numbers properly in some cases, and returned erroneous ranges of lines per segment 130S. For example, a first segment (S1) may be titled 130T as a “greetings” segment (correct), and may be defined by line numbers (1-3) (incorrect, should be 1-2), while a second segment (S2) may be titled as a “problem presentation” segment (correct), and may be defined by line numbers (3-6) (incorrect, overlapping (3) with segment S1).

Pertaining to the same example, enumerated, textual interaction data element 120P may include text lines 110L, as shown in corresponding Example 2, below:

### Example 2

1. Hello, my name is Daniel
2. Hi there
3. How may I help you?
4. I am having a problem with my phone
5. What seems to be the problem
6. The phone will not turn on . . .
   resulting in correct segmentation of the interaction to segments S1 (“greetings”, line numbers (1-2) and S2 (“problem presentation”, line numbers 3-6).

It may be appreciated that by employing prompt preparation, such as enumerating the textual representation of the interaction 110T (now 120P), embodiments of the invention may improve efficiency (e.g., in computing resources, such as computing cycles and data traffic) and cost of automated text analysis computing processes.

The at least one language model 130 may further generate metadata 10M for each segment, in addition to the aforementioned lists of line indices 130L. For example, system 10 may apply at least one language model 130 on lines 110L of each segment, to predict, or generate a segment title 130T for that segment, indicating a main topic or theme of that portion of the interaction.

In another example, system 10 may apply at least one language model 130 on lines 110L of each segment, to generate a segment description 130D, providing a brief summary or description of the content within that segment.

System 10 may associate the initial title 130T and/or description 130D to the list of line indices 130L of that segment, thereby producing a descriptive, segment metadata structure 10M. Segmentation system 10 may store segment metadata 10M (line index lists 130L, segment titles 130T and/or segment descriptions 130D) for each segment identified by language model 130 in an appropriate database or repository (e.g., storage 6 of FIG. 1).

The lists of line indices (segments) 130L generated by the first language model 130 may be passed to segmentation evaluation module 150 for further analysis. In some cases, the segmentation evaluation module 150 may assess the consistency and accuracy of the segmentation of interaction 40, as indicated by line indices 130L. For example, segmentation evaluation module 150 may evaluate the list 130L of line indices generated by the first language model 130, to identify any inconsistencies in the segmentation.

In some cases, segmentation evaluation module 150 may check for specific types of inconsistencies within the list of line indices 130L. Inconsistencies may include, for example, gaps in the list 130L of line indices, such as in the following list {(L₁,L₂,L₃); (L₄, L₆,L₇); (L₈,L₉,L₁₀)}, where L₅ is missing. Segmentation evaluation module 150 may identify any missing line 110L numbers between consecutive segments, which could indicate that portions of the interaction data 40 were not properly assigned to a segment.

In another example, segmentation evaluation module 150 may identify overlaps in the list of line indices 130L, e.g., instances where the same line indices are assigned to multiple segments such as in the following list {(L₁,L₂,L₃); (L₄,L₄,L₅,L₆,L₇); (L₈,L₉,L₁₀)} (where L₄, is duplicated), potentially indicating an error in the segmentation process.

In another example, segmentation evaluation module 150 may identify disorder within the list of line indices: Segmentation evaluation module 150 may check for any out-of-order line indices, such as in the following list {(L₁,L₂,L₄); (L₃,L₅,L₆,L₇); (L₈,L₉,L₁₀)} (where L₃ and L₄, are swapped), which could suggest an issue with the chronological flow of the segmentation.

By evaluating the list of line indices for such inconsistencies, the segmentation evaluation module 150 may help ensure the accuracy and reliability of the segmentation results. In some cases, if the segmentation evaluation module 150 identifies any inconsistencies, the segmentation system 10 may take further action to refine or correct the segmentation.

According to some embodiments, segmentation system 10 may employ a second language model 140 to refine, or amend the segmentation when inconsistencies are identified by the segmentation evaluation module 150. Second language model 140 may be more robust, and computationally intensive than the first language model 130. For example, as explained above, the inventors have experimentally implemented language model 130 by using a Claude 3 Haiku ML model. In this configuration, the second language model 140 may be Claude 3.5 Sonnet model, which is another machine learning model of the Claude family of LLMs.

According to some embodiments, when the segmentation evaluation module 150 identifies inconsistencies in the segmentation (list 130L) produced by the first language model 130, segmentation system 10 may activate the second language model 140 to generate a second list of line indices 140L, defining a refined segmentation.

The second language model 140 may receive the interaction data 40 (e.g., as enumerated, textual interaction data element 120P) and/or results 130L from the first language model 130 as inputs. In some cases, second language model 140 may analyze the entire interaction data 40 (120P) again, focusing on the areas where inconsistencies were identified by the segmentation evaluation module 150.

Similar to the first language model 130, second language model 140 may generate several outputs for each segment 140S in the refined segmentation, as new metadata 10M. These outputs may include a second segment index list 140L (segmentation), a second segment title 140T, and a second segment description 140D.

Second segment index list 140L may contain a refined, or amended list of line indices, in relation to list 130L, representing the segmentation of interaction data element 40 (120P) into segments of distinct topics. Refined list 140L may address the inconsistencies identified in the output list 130L of the first language model 130, such as gaps, overlaps, or disorder in the line indices.

In some cases, the second language model 140 may apply more sophisticated analysis techniques or use a larger knowledge base to generate more accurate and consistent segmentation results. The increased computational intensity of the second language model 140 may allow for a more thorough examination of the interaction data 40 and potentially resolve complex segmentation issues that the first language model 130 may have struggled with.

The outputs generated by the second language model 140 may be passed back to segmentation evaluation module 150 for further analysis. In some cases, segmentation evaluation module 150 may compare the refined segmentation from the second language model 140 with the original segmentation from the first language model 130 to verify that the inconsistencies have been resolved. Additionally, or alternatively, system 10 may use the refined segmentation (list 140L) of the second language model 140 as self-supervisory data, to retrain first language model 130 so as to fine-tune the prediction of list 130L.

By employing this two-tiered approach with the first language model 130 and the second language model 140, segmentation system 10 may balance efficiency and accuracy in the segmentation process. System 10 may use the faster and less computationally intensive first language model 130 for initial segmentation, reserving the more resource-intensive, and expensive second language model 140 for cases where refinement may be necessary.

Segmentation system 10 may include a title analysis module 160 and a title database 30, as illustrated in FIG. 2. These components may collaborate to refine and standardize the titles 130T/140T generated for each segment 130S/140S of the interaction data 40.

According to some embodiments, segmentation system 10 may employ a two-step process for generating segment titles 130T/140T. The first step may involve language model 130/140 generating initial titles 130T/140T, as described herein. In a second step, title analysis module 160 may be employed to compare these initial titles 130T/140T to a list of predefined titles 30, stored in a title database (e.g., storage 6 of FIG. 1). Where possible, title analysis module 160 may replace the initially generated titles 130T/140T with matching predefined titles 30, helping to maintain consistency in terminology across different interactions 40.

In some cases, the title analysis module 160 may compare each initial title with the predefined titles in the title database 30. Title analysis module 160 may use natural language processing techniques to evaluate the semantic similarity between the initial titles 130T/140T generated by language models 130/140 and a list of predefined titles stored in the title database 30.

Title database 30 may contain a set of standardized or preferred titles that the segmentation system 10 may use to maintain consistency across different interactions 40. When the semantic similarity between an initial title and a predefined title exceeds a predetermined threshold, the title analysis module 160 may replace the assigned initial title 130T/140T in the segment metadata structure 10M with the respective title from the title database 30. This process may help ensure that the titles used across different interactions 40 are consistent and align with the organization's preferred terminology.

For example, title analysis module 160 may include an ML-based language model, adapted to produce (i) a first embedding vector 160E (denoted 160E1), representing sematic meaning of initial title 130T/140T, and (ii) one or more second embedding vectors 160E (denoted 160E2), representing sematic meaning of respective one or more predefined titles 30. Title analysis module 160 may subsequently calculate an appropriate metric (e.g., cosine distance) between embedding vector 160E1 and the one or more embedding vectors 160E2, to determine similarity between embedding vector 160E1 and one or more (e.g., each) of embedding vectors 160E2. Title analysis module 160 may then replace an initially generated title 130T with a matching predefined title 30, when the calculated similarity (distance) surpasses (falls below) a predetermined threshold.

By employing this title analysis and customization process, segmentation system 10 may balance the flexibility of generating context-specific titles with the need for standardization and consistency in terminology. This approach may allow for more effective searching and categorization of interaction segments across multiple interactions 40.

Segmentation system 10 may include a user interface 170 for presenting segmentation 130S/140S results to users. In some embodiments, user interface 170 may receive segmentation data (e.g., lines 130L/140L, titles 130T/140T and/or descriptions 130D/140D) from other components of the segmentation system 10 and display this information in a structured and user-friendly format.

User interface 170 may present segment metadata structures 10M generated by the segmentation system 10. These segment metadata structures 10M may include information such as segment titles 130T/140T, descriptions 130D/140D, and associated lists of line indices 130L/140L. In some cases, user interface 170 may allow for expanding all segments at once or each segment individually, providing users with flexibility in viewing and interacting with the segmented data.

Segmentation system 10 may enable search functionality via the user interface 170. This search functionality may allow users to search the interaction data 40 based on the titles and descriptions contained within the segment metadata structures. By leveraging metadata structures 10M, the search functionality may provide more targeted and efficient search results compared to searching the raw interaction data 40. In some cases, the segmentation system 10 may store the descriptive segment metadata structures 10M and associated interaction data elements in a database. This database may be part of the storage system 6 illustrated in FIG. 1, or may be a separate storage component within the segmentation system 10.

The user interface 170 may include features for receiving search queries, e.g., from users. When a user enters a search query through user interface 170, segmentation system 10 may search the database 6 to identify matching segment metadata structures 10M based on the search query. This search process may involve comparing the query terms against titles 130T/140T, descriptions 130D/140D, and/or other metadata 10M associated with each segment 130S/140S.

After identifying matching segment metadata structures 10M, segmentation system 10 may retrieve lines 110L or snippets from the interaction data elements 40 (120P) associated with these matching structures. Segmentation system 10 may then present the retrieved lines 110L or snippets on the user interface 170, providing users with relevant excerpts from the original interactions 40.

In addition to the retrieved lines 110L or snippets, user interface 170 may display contextual information alongside the search results. This contextual information may include details such as the associated segment titles 30/130T/140T, descriptions 130D/140D, line indices 130L/140L, participant information (e.g., name), timestamps, domain or location, and the like. By providing this additional context, user interface 170 may help users better understand the relevance and significance of each search result within a broader interaction.

The combination of segment metadata presentation, search functionality, and contextual result display may enhance the user's ability to navigate and analyze large volumes of interaction data efficiently. Users may quickly locate specific topics or themes within interactions 40, review relevant excerpts, and understand the context of these excerpts within the broader conversation.

Segmentation system 10 may incorporate additional capabilities to enhance its functionality and support various interaction scenarios. In some cases, the segmentation system 10 may be capable of handling interactions 40 in multiple languages. For example, the at least one language model 130/140 may be, or may include two or more language-specific models. These language-specific models may be designed to process and analyze interactions 40 in different languages effectively.

In some embodiments, preparation module 120 may detect multiple languages within the interaction data 40. The preparation module 120 may analyze the textual content 110T of the interaction data 40 to identify the presence of different languages within the same interaction. Upon detecting multiple languages, the segmentation system 10 may apply a language-specific model for segmentation and title generation in each detected language. This approach may allow for more accurate and contextually appropriate segmentation across different languages within a single interaction.

Segmentation system 10 may consolidate results of segment metadata structures 10M from each of the language-specific models 130/140 into a unified set of segment metadata structures 10M. This consolidation process may involve aligning segments across languages, merging overlapping segments, and ensuring consistency in the overall segmentation structure. User interface 170 may present the consolidated segment metadata structures to users, allowing them to view and interact with multi-language interactions 40 in a coherent manner. In some cases, user interface 170 may provide options for users to switch between different language views or display translations alongside the original text 110T.

Segmentation system 10 may incorporate a feedback mechanism, to continuously improve its performance. For example, user interface 170 may receive feedback on the generated segment metadata structures from users. This feedback may include corrections to segment boundaries (e.g., line index lists 130L/140L), suggestions for more appropriate titles 130T/140T, indications of misclassified, or poorly described content 130D/140D. Segmentation system 10 may store the feedback in association with the corresponding interaction data 40 elements and respective generated segments' 130S/140S metadata 10M. This association may allow system 10 to maintain a record of user-provided improvements and corrections for specific interactions 40 and segments.

Additionally, or alternatively, segmentation system 10 may periodically retrain the first language model 130 and/or the second language model 140 using the stored user feedback as supervisory data, to improve segmentation accuracy. This retraining process may involve updating the models' parameters based on the collected feedback, potentially enhancing their ability to generate more accurate and relevant segmentations over time. The feedback-based retraining may be beneficial, for example, for improving the performance of language-specific models within the first language model 130. By incorporating user feedback specific to each language, the segmentation system 10 may enhance its ability to handle nuances and idiomatic expressions across different languages.

These additional capabilities may allow the segmentation system 10 to adapt to diverse interaction scenarios, handle multi-language content effectively, and continuously improve its performance based on user feedback. By integrating these features, segmentation system 10 may provide a cost-effective, robust and versatile solution for analyzing and segmenting interaction data 40 across various contexts and languages.

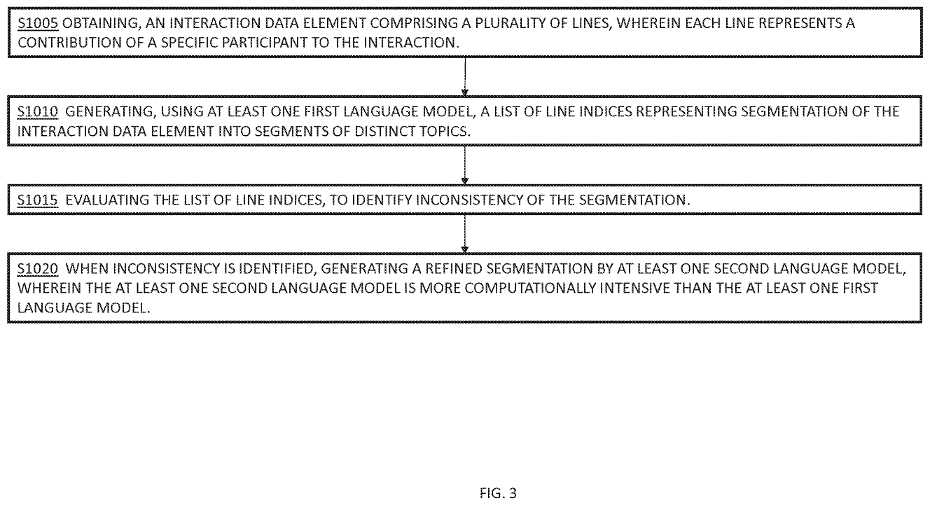

Reference is now made to FIG. 3, which is a flowchart, showing a process of segmenting interactions (e.g., interaction(s) 40 of FIG. 2) by at least one processor (e.g., processor 2 of FIG. 1) of a computing device (e.g., computing device 10 of FIG. 1), according to aspects of the present invention.

As shown in step S1005, processor 2 may obtain an interaction data element (e.g., textual representation 110T of FIG. 2) that may include a plurality of text lines. Each line may represent a contribution of a specific participant (e.g., a human agent, a human customer, and the like) to interaction 40.

As shown in step S1010, processor 2 may use at least one first language model (e.g., LLM 130 of FIG. 2) to generate a list of line indices 130L that represent segmentation of the interaction data element 110T into segments (e.g., 130S of FIG. 2) of distinct topics (e.g., defined by different titles 130T of FIG. 2).

As shown in step S1015, processor 2 may evaluate (150 of FIG. 2) the list of line indices 130L, to identify inconsistency of the segmentation, as elaborated herein. When inconsistency is identified (step S1020), processor 2 may generate a refined segmentation (e.g., 140S of FIG. 2) by at least one second language model (e.g., 140 of FIG. 2). The at least one second language model 140 may be more computationally intensive than the at least one first language model 130.

Embodiments of the invention may thereby provide a practical application for improving efficiency of automated text analysis, in both aspects of computational resources (e.g., computational cycles, memory and data traffic), and financial costs of implementation.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method for segmenting an interaction into a plurality of segments of distinct topics, by at least one processor, the method comprising:
obtaining an interaction data element comprising a plurality of lines, wherein each line represents a contribution of a specific participant to the interaction;
generating, using at least one first language model, a list of line indices representing segmentation of the interaction data element into the plurality of segments of distinct topics;
evaluating the list of line indices, to identify inconsistency of the segmentation; and
when inconsistency is identified, generating a refined segmentation of the plurality of segments of distinct topics by at least one second language model, wherein the at least one second language model is more computationally intensive than the at least one first language model.

2. The method of claim 1, wherein said inconsistency is selected from a list comprising: (i) a gap in the list of line indices, (ii) an overlap in the list of line indices, and (iii) disorder within the list of line indices.

3. The method of claim 2, further comprising for each segment of the plurality of segments of distinct topics:
applying the at least one first language model on lines of the segment, to generate an initial title indicative of the segment's topic;
applying the at least one first language model on lines of the segment to generate a description of content of the segment; and
associating the initial title and description to line indices of that segment thereby producing a descriptive segment metadata structure.

4. The method of claim 3, further comprising:
evaluating semantic similarity between the generated initial title and titles of a list of predefined titles; and
when the semantic similarity exceeds a predetermined threshold, replacing the assigned initial title in the segment metadata structure with a respective title from the list of predefined titles.

5. The method of claim 3, further comprising:
presenting the segment metadata structures on a user interface; and
enabling search functionality via the user interface, wherein the search functionality allows searching of the interaction data element based on the titles and descriptions of the segment metadata structures.

6. The method of claim 5, further comprising:
storing the descriptive segment metadata structures and associated interaction data elements in a database;
receiving a search query through the user interface;
searching the database to identify matching segment metadata structures based on the search query;
retrieving lines or snippets from the interaction data elements associated with the matching segment metadata structures; and
presenting the retrieved lines or snippets on the user interface, along with contextual information including at least one of: the associated titles, descriptions, line indices, participant information, and timestamps.

7. The method of claim 1, wherein obtaining the interaction data element comprises:
receiving audio data of the interaction;
transcribing the audio data, to obtain textual representation of the interaction;
identifying participants in the interaction;
enumerating lines of the transcribed text to distinguish between contributions of each identified participant; and
associating each enumerated line with its corresponding participant.

8. The method of claim 3, wherein the at least one first language model comprises two or more language-specific models, and wherein the method further comprises:
detecting multiple languages within the interaction data element;
applying a language-specific model for segmentation and title generation in each detected language; and
consolidating results of descriptive segment metadata structures from each of the language-specific models into a unified set of segment metadata structures.

9. The method of claim 3, further comprising:
receiving, via a user interface, feedback on the generated segment metadata structures;
storing the feedback in association with the corresponding interaction data elements and generated description; and
periodically retraining the at least one first language model and the at least one second language model using the stored user feedback to improve segmentation accuracy.

10. A system for segmenting interactions, the system comprising: a non-transitory memory device, wherein modules of instruction code are stored, and at least one processor associated with the memory device, and configured to execute the modules of instruction code, whereupon execution of said modules of instruction code, the at least one processor is configured to:
obtain an interaction data element comprising a plurality of lines, wherein each line represents a contribution of a specific participant to the interaction;
generate, using at least one first language model, a list of line indices representing segmentation of the interaction data element into segments of distinct topics;
evaluate the list of line indices, to identify inconsistency of the segmentation; and
when inconsistency is identified, generate a refined segmentation by at least one second language model, wherein the at least one second language model is more computationally intensive than the at least one first language model.

11. The system of claim 10, wherein said inconsistency is selected from a list comprising: (i) a gap in the list of line indices, (ii) an overlap in the list of line indices, and (iii) disorder within the list of line indices.

12. The system of claim 11, wherein the at least one processor is further configured to, for each segment:
apply the at least one first language model on lines of the segment, to generate an initial title indicative of the segment's topic;
apply the at least one first language model on lines of the segment, to generate a description of content of the segment; and
associate the initial title and description to line indices of that segment, thereby producing a descriptive, segment metadata structure.

13. The system of claim 12, wherein the at least one processor is further configured to:
evaluate semantic similarity between the generated initial title and titles of a list of predefined titles; and
when the semantic similarity exceeds a predetermined threshold, replace the assigned initial title in the segment metadata structure with a respective title from the list of predefined titles.

14. The system of claim 12, wherein the at least one processor is further configured to:
present the segment metadata structures on a user interface; and
enable search functionality via the user interface, wherein the search functionality allows searching of the interaction data element based on the titles and descriptions of the segment metadata structures.

15. The system of claim 14, wherein the at least one processor is further configured to:
store the descriptive segment metadata structures and associated interaction data elements in a database;
receive a search query through the user interface;
search the database to identify matching segment metadata structures based on the search query;
retrieve lines or snippets from the interaction data elements associated with the matching segment metadata structures; and
present the retrieved lines or snippets on the user interface, along with contextual information, selected from a list comprising at least one of: the associated titles, descriptions, line indices, participant information, and timestamps.

16. The system of claim 10, wherein the at least one processor is further configured to obtain the interaction data element by:
receiving audio data of the interaction;
transcribing the audio data, to obtain textual representation of the interaction;
identifying participants in the interaction;
enumerating lines of the transcribed text to distinguish between contributions of each identified participant; and
associating each enumerated line with its corresponding participant.

17. The system of claim 12, wherein the at least one first language model comprises two or more language-specific models, and wherein the at least one processor is further configured to:
detect multiple languages within the interaction data element;
apply a language-specific model for segmentation and title generation in each detected language; and
consolidate results of segment metadata structures from each of the language-specific models into a unified set of segment metadata structures.

18. The system of claim 12, wherein the at least one processor is further configured to:
receive, via a user interface, feedback on the generated segment metadata structures;
store the feedback in association with the corresponding interaction data elements and generated description; and
periodically retrain the at least one first language model and the at least one second language model using the stored user feedback to improve segmentation accuracy.
